(19) United States
(12) Patent Application Publication
(10) Pub. No.: US 2012/0214494 A1
(43) Pub. Date: Aug. 23, 2012

(54) PROXIED USER EQUIPMENT WAKE UP USING CELL CHANGE MECHANISM

(75) Inventors: Olufunmilola O. Awoniyi, San Diego, CA (US); Samir S. Soliman, San Diego, CA (US)

(73) Assignee: QUALCOMM Incorporated, San Diego, CA (US)

(21) Appl. No.: 13/032,981

(22) Filed: Feb. 23, 2011

(51) Int. Cl. H04W 36/30; H04W 76/00

(52) U.S. Cl. 455/439; 455/422.1

(57) ABSTRACT

An apparatus for use in a wireless communication network that includes a wireless network user equipment (UE), a communication node, and a network controller, includes: a first transceiver configured to communicate with another entity of the wireless network; and a processor, communicatively coupled to the first transceiver, configured to determine that a particular UE is being proxied by a proxy of the network and configured to respond to an indication of receipt of data intended for the particular UE of the plurality of UEs by inducing an intra-cell change by the network controller for the particular UE.

### BACKGROUND

Information communication provided by various forms of networks is in wide use in the world today. Networks having multiple nodes in communication using wireless and wireline links are used, for example, to carry voice and/or data. The nodes of such networks may be computers, personal digital assistants (PDAs), phones, servers, routers, switches, multiplexers, modems, radios, access points, base stations, etc. Many client device nodes (also referred to as user equipment (UE) or access terminals (ATs)), such as cellular phones, PDAs, laptop computers, etc. are mobile and thus may connect with a network through a number of different interfaces.

Mobile client devices may connect with a network wirelessly via a base station, access point, wireless router, etc. (collectively referred to herein as access points). A mobile client device may remain within the service area of such an access point for a relatively long period of time (referred to as being “camped on” the access point) or may travel relatively rapidly through access point service areas, with cellular handoff or reselection techniques being used for maintaining a communication session or for idle mode operation as association with access points is changed.

Issues with respect to available spectrum, bandwidth, capacity, etc. may result in a network interface being unavailable or inadequate between a particular client device and access point. Moreover, issues with respect to wireless signal propagation, such as shadowing, multipath fading, interference, etc., may result in a network interface being unavailable or inadequate between a particular client device and access point.

Cellular networks have employed the use of various cell types, such as macrocells, microcells, picocells, and femtocells, to provide desired bandwidth, capacity, and wireless communication coverage within service areas. For example, the use of femtocells is often desirable to provide wireless communication in areas of poor network coverage (e.g., inside of buildings), to provide increased network capacity, to utilize broadband network capacity for backhaul, etc.

Femtocell transmit power is typically a tradeoff between interference (i.e., femtocell signal transmit levels causing interference for other nodes of the network) and reliable detection (i.e., femtocell transmit levels being sufficient for reliable detection by nodes wishing to communicate with the femtocell). If the femtocell transmit power is high, mobile client devices can more readily detect and associate with an available femtocell. However, such femtocell transmissions are more likely to interfere with other nodes not wishing to communicate with the femtocell, such as nodes in communication with an overlying macrocell. If the femtocell transmit power is low, interference with such other nodes can be mitigated, but mobile client devices may not be readily able to detect and associate with the femtocell.

Mobile client devices generally operate using an internal power supply, such as a small battery, to facilitate their highly mobile operation. Typical operation to provide femtocell system selection, however, has an appreciable impact upon the power utilized by a mobile client device. Searching for available femtocells within range, negotiating links, etc. in typical use scenarios will often result in a reduction of the mobile client device standby time operation available from the internal power supply by approximately 10%. For example, an internal power supply may be appreciably drained as a result of a mobile client device continuing to search for femtocells whether or not appropriate femtocells are in range of the mobile client device.

### SUMMARY

An example of apparatus for use in a wireless communication network that includes a wireless network user equipment (UE), a communication node, and a network controller, includes: a first transceiver configured to communicate with another entity of the wireless network; and a processor, communicatively coupled to the first transceiver, configured to determine that a particular UE is being proxied by a proxy of the network and configured to respond to an indication of receipt of data intended for the particular UE of the plurality of UEs by inducing an intra-cell change by the network controller for the particular UE.

Implementations of such an apparatus may include one or more of the following features. The processor is configured to provide a request for the intra-cell change. The apparatus is the proxy for the UE and the processor is configured to send the request toward the network controller, the request being a measurement report indicating a poor communication link to the particular UE. The apparatus is the network controller and the processor is configured to produce the request, the request being a measurement report indicating a poor communication link to the particular UE. The apparatus is the proxy and the first transceiver is configured to communicate with the plurality of UEs using a first frequency band that is different from a second frequency band in which the UEs are configured to communicate wirelessly with the communication node, the apparatus further including a second transceiver configured to communicate with the network node and the network controller using the second frequency band, where the processor is configured to respond to receipt of a channel reconfiguration message by sending a channel reconfiguration complete message toward the network controller, the channel reconfiguration message indicating parameters for a particular physical channel between the particular UE and the communication node, and the channel reconfiguration complete message indicating availability of communication with the particular UE using the particular physical channel. The processor is further configured to respond to receiving the channel reconfiguration message by sending a wake-up request toward the particular UE via the first transceiver. The first transceiver is configured to communicate wirelessly with the UEs using a short-range wireless protocol. The processor is configured to induce a high-speed downlink shared channel cell change procedure at the network controller.

An example of a computer program product for use in a wireless network that includes a wireless network user equipment (UE), a communication node, and a network controller, includes: non-transitory processor-readable memory including processor-readable instructions configured to cause a processor to: determine that data are to be sent from the communication node to the UE; determine that the UE is presently in a mode in which the UE is unable to receive the data from the communication node; and induce an intra-cell change by the network controller for the UE.

Implementations of such a computer program product may include one or more of the following features. The instructions configured to cause the processor to induce are configured to cause the processor to provide a measurement report indicating a poor communication link to the UE. The instructions configured to cause the processor to induce are configured to cause the processor to induce a high-speed downlink shared channel cell change procedure at the network controller. The instructions configured to cause the processor to induce are configured to cause the processor to provide a request for an intra-cell change. The instructions configured to cause the processor to induce are configured to cause the processor to send a communication toward the network controller. The instructions configured to cause the processor to induce are configured to cause the processor to produce a fake measurement report within the network controller. The memory further includes processor-readable instructions configured to cause the processor to respond to a channel reconfiguration message from the network controller intended for the UE by sending a channel reconfiguration complete message toward the network controller, the channel reconfiguration message indicating parameters for a particular physical channel between the UE and the communication node, and the channel reconfiguration complete message indicating availability of communication with the particular UE using the particular physical channel. The memory further includes processor-readable instructions configured to cause the processor to respond to the channel reconfiguration message by initiating transmission of a wake-up request toward the UE using a frequency band other than that used by the UE to communicate with the communication node.

An example of a method of proxying user equipment (UE) in a wireless communication network that includes a plurality of UEs, a communication node, and a network controller communicatively coupled to the communication node, includes: monitoring at least one of the network controller or the communication node for data intended for a particular UE of the plurality of UEs, where the particular UE is presently in a first mode in which the UE has reduced data-reception capability compared to a second mode of the UE; determining that at least one of the network controller or the communication node receives data intended for the particular UE; and inhibiting transmission of the data by the communication node while the particular UE changes from the first mode to the second mode.

Implementations of such a method may include one or more of the following features. The inhibiting includes inducing an intra-cell change by the network controller for the particular UE. The method further includes: sending a channel reconfiguration message from the network controller to the proxy indicating parameters for a physical channel between the particular UE and the communication node; and sending a channel reconfiguration complete message from the proxy to the network controller indicating availability of communication with the particular UE using the physical channel. The method further includes sending the channel reconfiguration message including an activation timer indicating a desired time of sufficient length for the particular UE to change from the first mode to the second mode. The method further includes receiving a preferred value of the activation timer and transmitting the preferred value to the communication node. Inducing the intra-cell change includes sending a communication from a proxy of the particular UE to the network controller to induce a high-speed downlink shared channel cell change procedure. Inducing the intra-cell change includes producing a fake measurement report in the network controller. The method further includes sending a request from a proxy of the particular UE to the particular UE using a first frequency band that is different from a second frequency band that is used by the communication node and the particular UE to communicate with each other.

An example of an apparatus for use in proxying user equipment (UE) in a wireless communication network that includes a plurality of UEs, a communication node, and a network controller communicatively coupled to the communication node, includes: monitoring means for monitoring at least one of the network controller or the communication node for data intended for a particular UE of the plurality of UEs, where the particular UE is presently in a first mode in which the particular UE has reduced data-reception capability compared to a second mode of the particular UE; determining means for determining receipt of data intended the particular UE; and inhibiting means for inhibiting transmission of the data by the communication node while the particular UE changes from the first mode to the second mode.

Implementations of such an apparatus may include one or more of the following features. The inhibiting means includes inducing means for inducing an intra-cell change by the network controller for the particular UE. The inducing means are configured to send a communication toward the network controller to induce a high-speed downlink shared channel cell change procedure. The communication is a measurement report indicating a poor communication link to the particular UE. The inducing means are disposed in the network controller and are configured to produce a fake measurement report. The apparatus further includes means for responding to a channel reconfiguration message from the network controller indicating parameters for a physical channel between the particular UE and the communication node by sending a channel reconfiguration complete message toward the network controller indicating availability of communication with the particular UE using the physical channel. The apparatus further includes wake-up means for sending a request toward the particular UE for the particular UE to change from the first mode to the second mode, the wake-up means configured to send the request using a first frequency band that is different from a second frequency band that is used by the communication node and the particular UE to communicate with each other. The apparatus further includes the communication node and the network controller.

Items and/or techniques described herein may provide one or more of the following capabilities. Power consumption of a mobile device may be reduced. Mobile devices in reduced-power modes can be woken up in response to data being received that is intended for the mobile devices, without losing the data. Data intended for sleeping mobile devices can be buffered in a Node B without changes to the 3GPP standard. While item/technique-effect pairs have been described, it may be possible for a noted effect to be achieved by means other than those noted, and a noted item/technique may not necessarily yield the noted effect.

### BRIEF DESCRIPTION OF THE DRAWINGS

A further understanding of the nature and advantages of examples provided by the disclosure may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, the reference numeral refers to all such similar components.

FIG. 1 is a block diagram of a wireless communications system;

FIG. 2A is a block diagram of a wireless communications system that includes a femto-proxy system;

FIG. 2B is a block diagram of a wireless communications system that includes an architecture of a femto-proxy system that is different from the architecture shown in FIG. 2A;

FIG. 3 is a block diagram of a processor module for implementing functionality of a communications management subsystem shown in FIG. 2A;

FIG. 4 is a block diagram of a femtocell architecture for circuit switched and data services using legacy interfaces;

FIG. 5 is a block diagram of user equipment for use with the femto-proxy systems of FIGS. 2A and 2B in the context of the communications systems and networks of FIGS. 1-4;

FIG. 6 is a signaling flow diagram of communications to assist in or otherwise facilitate a user equipment request for proxy services and a femtocell setup process in preparation for providing proxy services to the user equipment;

FIG. 7 is a block flow diagram of a process of proxying user equipment and storing data while the user equipment is woken up; and

FIG. 8 is a signaling flow diagram of the process shown in FIG. 7.

### DETAILED DESCRIPTION

Techniques are provided herein for reducing power used by user equipment in femtocells while retaining the ability to transfer data to the user equipment without losing portions of the data. For example, user equipment is put to sleep to reduce power by shutting down components used to communicate with a femtocell, e.g., a Node B and radio network controller. Data intended for the user equipment are detected by a proxy of the user equipment, and the proxy initiates an intra-cell change with a network controller using an intra-Node B cell change procedure according to the 3GPP standard. During the cell-change procedure, the data are stored in a Node B while the user equipment is woken up in response to an out-of-band notice. The data are transferred to the awake user equipment over an in-band channel, established by the High Speed Downlink Shared Channel (HS-DSCH) procedure, from the Node B.

As used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C). A wireless communication network does not have all communications transmitted wirelessly, but is configured to have at least some communications transmitted wirelessly.

Techniques described herein may be used for various wireless communication systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856s commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Thus, the following description provides examples, and is not limiting of the scope, applicability, or configuration set forth in the claims. Changes may be made in the function and arrangement of elements discussed without departing from the spirit and scope of the disclosure. Various examples may omit, substitute, or add various procedures or components as appropriate. For instance, the methods described may be performed in an order different from that described, and various operations may be added, omitted, or combined. Also, features described with respect to certain examples may be combined in other examples.

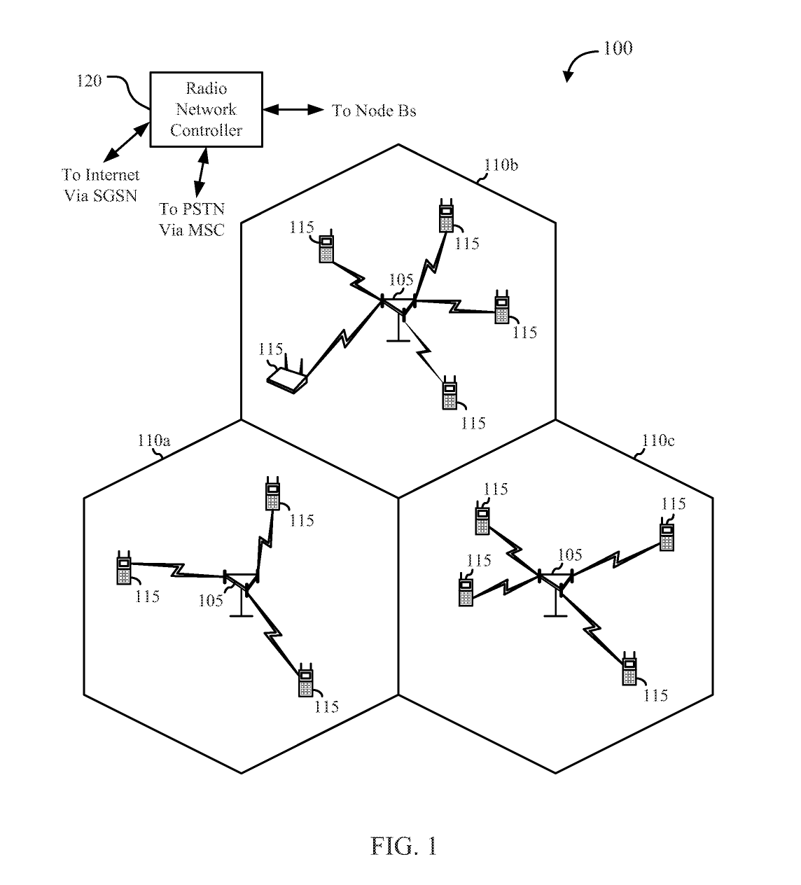

Referring first to FIG. 1, a block diagram illustrates an example of a wireless communications system 100. The system 100 includes communication nodes, here Node Bs 105, disposed in cells 110, mobile user equipment 115 (UEs), and a radio network controller (RNC) 120. For certain systems, the functionality of the Node B 105 and the RNC 120 may be combined in one network entity. The system 100 may support operation on multiple carriers (waveform signals of different frequencies). Multi-carrier transmitters can transmit modulated signals simultaneously on the multiple carriers. Each modulated signal may be a CDMA signal, a TDMA signal, an OFDMA signal, a SC-FDMA signal, etc. Each modulated signal may be sent on a different carrier and may carry pilot, control information, data, etc. The system 100 may be a multi-carrier network capable of efficiently allocating network resources.

The Node Bs 105 can wirelessly communicate with the UEs 115 via a base station antenna. The Node Bs 105 are configured to communicate with the UEs 115 under the control of the RNC 120 via multiple carriers. Each of the Node Bs 105 can provide communication coverage for a respective geographic area, here the cell 110-a, 110-b, or 110-c. The system 100 may include Node Bs 105 of different types, e.g., macro, pico, and/or femto base stations.

The UEs 115 can be dispersed throughout the cells 110. The UEs 115 may be referred to as mobile stations, mobile devices, user equipment (UE), or subscriber units. The UEs 115 here include cellular phones and a wireless communication device, but can also include personal digital assistants (PDAs), other handheld devices, netbooks, notebook computers, etc.

For the discussion below, the UEs 115 operate on (are “camped” on) a macro or similar network facilitated by multiple “macro” Node Bs 105. Each macro Node B 105 may cover a relatively large geographic area (e.g., several kilometers in radius) and may allow unrestricted access by terminals with service subscription. The UEs 115 may be previously registered to operate on at least one femto network facilitated by a “femto” or Home Node B (HNB) that typically contains the functionality of the Node B 105 and the RNC 120.

The UE 115 may generally operate using an internal power supply, such as a small battery, to facilitate highly mobile operation. Strategic deployment of network devices, such as femtocells, can mitigate mobile device power consumption to some extent. For example, femtocells may be utilized to provide service within areas which might not otherwise experience adequate or even any service (e.g., due to capacity limitations, bandwidth limitations, signal fading, signal shadowing, etc.), thereby allowing client devices to reduce searching times, to reduce transmit power, to reduce transmit times, etc. Femtocells (e.g., femto Node Bs 105) provide service within a relatively small service area (e.g., within a house or building). Accordingly, a client device is typically disposed near a femtocell when being served, often allowing the client device to communicate with reduced transmission power.

For example, the femto cell is implemented as a Node B (HNB) located in a user premises, such as a residence, an office building, etc. The location may be chosen for maximum coverage (e.g., in a centralized location), to allow access to a global positioning satellite (GPS) signal (e.g., near a window), and/or in any other useful location. For the sake of clarity, the disclosure herein assumes that a set of UEs 115 are registered for (e.g., on a white list of) a single HNB that provides coverage over substantially an entire user premises. The “home” Node B (HNB) provides the UEs 115 with access to communication services over the macro network. As used herein, the macro network is assumed to be a wireless wide-area network (WWAN). As such, terms like “macro network” and “WWAN network” are interchangeable. Similar techniques may be applied to other types of network environments, HNB coverage topologies, etc., without departing from the scope of the disclosure or claims.

In example configurations, the HNB is integrated with one or more out-of-band (OOB) proxies as a femto-proxy system. As used herein, “out-of-band,” or “OOB,” includes any type of communications that are out of band with respect to the macro network. For example, the OOB proxies and/or the UEs 115 may be configured to operate using Bluetooth (e.g., class 1, class 1.5, and/or class 2), ZigBee (e.g., according to the IEEE 802.15.4-2003 wireless standard), and/or any other useful type of communications out of the macro network band.

OOB integration with the HNB may provide a number of features. For example, the OOB proxies may allow for reduced interference, lower power HNB registration and/or reselection, etc.

Further, the integration of OOB functionality with the HNB may allow the UEs 115 attached to the HNB to also be part of an OOB piconet. The piconet may facilitate enhanced HNB functionality, other communications services, power management functionality, and/or other features to the UEs 115. These and other features will be further appreciated from the description below.

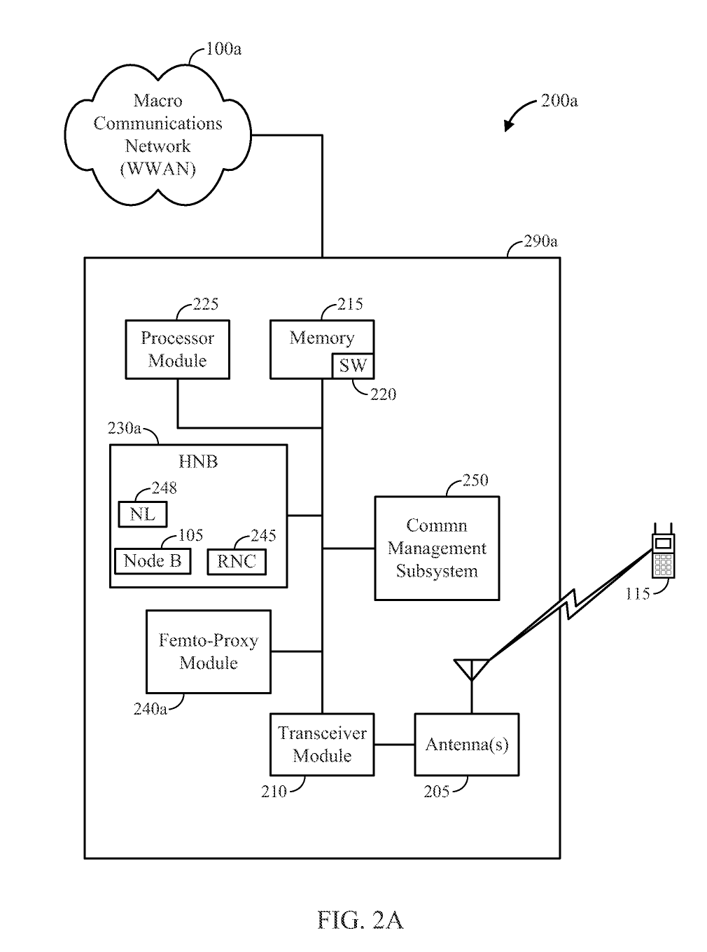

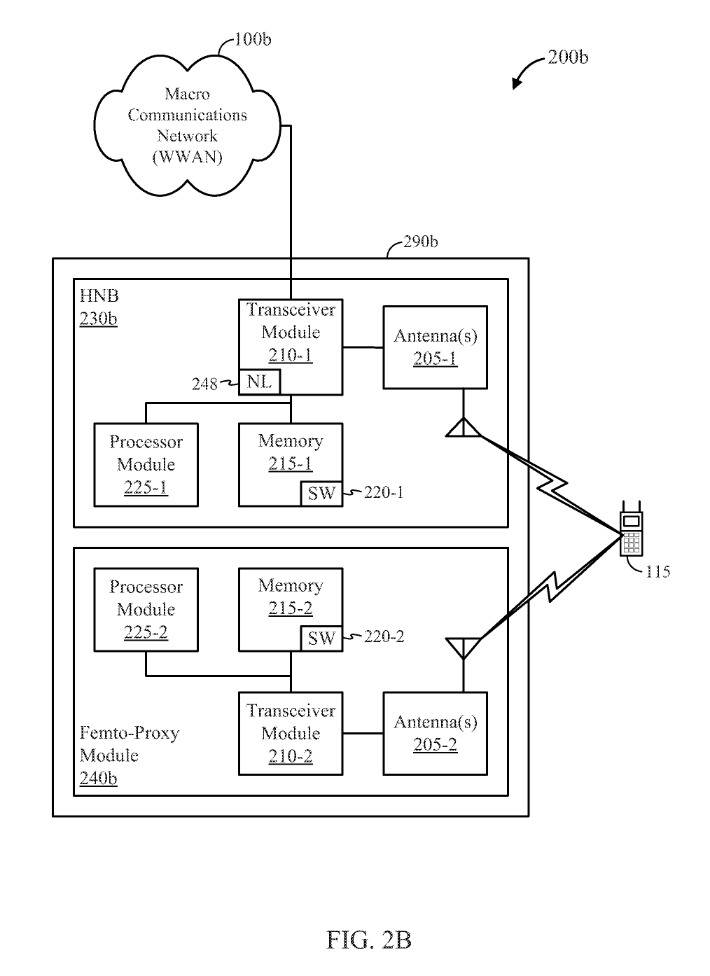

FIG. 2A shows a block diagram of a wireless communications system 200 that includes a femto-proxy system 290a. The femto-proxy system 290a includes an HNB 230a, and a communications management subsystem 250. The HNB 230a includes a femto-proxy module 240a (although this module could be separate from the HNB 230a), the Node B 105, a radio network controller (RNC) 245, and a network listen (NL) module 248. The NL module 248 can monitor signals from other macro base stations, and this information can be used for self-configuration, interference management, etc. The femto-proxy system 290a includes the femto-proxy module 240a that provides the OOB functionality. The HNB 230a may be a femto Node B 105, as described with reference to FIG. 1. The femto-proxy system 290a also includes antennas 205, a transceiver module 210, memory 215, and a processor module 225, which each may be in communication, directly or indirectly, with each other (e.g., over one or more buses). The transceiver module 210 is configured to communicate bi-directionally, via the antennas 205, with the UEs 115. The femto-proxy system 290a is also configured to communicate bi-directionally (through a wired or wireless link) with a macro communications network 100a (e.g., a WWAN). The macro communications network 100a may be the communications system 100 of FIG. 1.

The memory 215 may include random access memory (RAM) and read-only memory (ROM). The memory 215 may store computer-readable, computer-executable software code 220 containing instructions that are configured to, when executed, cause the processor module 225 to perform various functions described herein (e.g., call processing, database management, message routing, etc.). Alternatively, the software 220 may not be directly executable by the processor module 225 but be configured to cause the computer, e.g., when compiled and executed, to perform functions described herein.

The processor module 225 may include an intelligent hardware device, e.g., a central processing unit (CPU) such as those made by Intel® Corporation or AMD®, a microcontroller, an application specific integrated circuit (ASIC), etc. The processor module 225 may include a speech encoder (not shown) configured to receive audio via a microphone, convert the audio into packets (e.g., 30 ms in length) representative of the received audio, provide the audio packets to the transceiver module 210, and provide indications of whether a user is speaking Alternatively, an encoder may only provide packets to the transceiver module 210, with the provision or withholding/suppression of the packet itself providing the indication of whether a user is speaking

The transceiver module 210 may include a modem configured to modulate the packets and provide the modulated packets to the antennas 205 for transmission, and to demodulate packets received from the antennas 205. While some examples of the system 290a may include a single antenna 205, the system 290 preferably includes multiple antennas 205 for multiple links. For example, one or more links may be used to support macro communications with the UEs 115. Also, one or more out-of-band links may be supported by the same antenna 205 or different antennas 205.

Notably, the femto-proxy system 290a is configured to provide both HNB 230a and femto-proxy module 240a functionality. For example, when the UE 115 approaches the femtocell coverage area, the UE's 115 OOB radio may begin searching for the OOB femto-proxy module 240a. Upon discovery, the UE 115 may have a high level of confidence that it is in proximity to the femtocell coverage area, and a scan for the HNB 230a can commence.

The scan for the HNB 230a may be implemented in different ways. For example, due to the femto-proxy module 240a discovery by the UE's 115 OOB radio, both the UE 115 and the femto-proxy system 290a may be aware of each other's proximity. The UE 115 scans for the HNB 230a. Alternatively, the HNB 230a polls for the UE 115 (e.g., individually, or as part of a round-robin polling of all registered UEs 115), and the UE 115 listens for the poll. When the scan for the HNB 230a is successful, the UE 115 may attach to the HNB 230a.

When the UE 115 is in the femtocell coverage area and attached to the HNB 230a, the UE 115 may be in communication with the macro communications network 100a via the HNB 230a. As described above, the UE 115 may also be a slave of a piconet for which the femto-proxy module 240a acts as the master. For example, the piconet may operate using Bluetooth and may include Bluetooth communications links facilitated by a Bluetooth radio (e.g., implemented as part of the transceiver module 210) in the HNB 230a.

Examples of the HNB 230a have various configurations of base station or wireless access point equipment. As used herein, the HNB 230a may be a device that communicates with various terminals (e.g., client devices (UEs 115, etc.), proximity agent devices, etc.) and may also be referred to as, and include some or all the functionality of, a base station, a Node B, an RNC, and/or other similar devices. Although referred to herein as the HNB 230a, the concepts herein are applicable to access point configurations other than femtocell configuration (e.g., picocells, microcells, etc.). Examples of the HNB 230a utilize communication frequencies and protocols native to a corresponding cellular network (e.g., the macro communications network 100a, or a portion thereof) to facilitate communication within a femtocell coverage area associated with the HNB 230a (e.g., to provide improved coverage of an area, to provide increased capacity, to provide increased bandwidth, etc.).

The HNB 230a may be in communication with other interfaces not explicitly shown in FIG. 2A. For example, the HNB 230a may be in communication with a native cellular interface as part of the transceiver module 210 (e.g., a specialized transceiver utilizing cellular network communication techniques that may consume relatively large amounts of power in operation) for communicating with various appropriately configured devices, such as the UE 115, through a native cellular wireless link (e.g., an “in band” communication link). Such a communication interface may operate according to various communication standards, including but not limited to wideband code division multiple access (W-CDMA), CDMA2000, global system for mobile telecommunication (GSM), worldwide interoperability for microwave access (WiMax), and wireless LAN (WLAN). Also or alternatively, the HNB 230a may be in communication with one or more backend network interfaces (e.g., a backhaul interface providing communication via the Internet, a packet switched network, a circuit-switched network, a radio network, a control network, a wired link, and/or the like) for communicating with various devices or other networks.

As described above, the HNB 230a may further be in communication with one or more OOB interfaces as part of the transceiver module 210 and/or the femto-proxy module 240a. For example, the OOB interfaces may include transceivers that consume relatively low amounts of power in operation and/or may cause less interference in the in-band spectrum with respect to the in-band transceivers. Such an OOB interface may be utilized according to embodiments to provide low power wireless communications with respect to various appropriately configured devices, such as an OOB radio of the UE 115. The OOB interface may, for example, provide a Bluetooth link, an ultra-wideband (UWB) link, an IEEE 802.11 (WLAN) link, etc.

The terms “high power” and “low power” as used herein are relative terms and do not imply a particular level of power consumption. Accordingly, OOB devices (e.g., OOB femto-proxy module 240a) may simply consume less power than native cellular interface (e.g., for macro WWAN communications) for a given time of operation. In some implementations, OOB interfaces also provide relatively lower bandwidth communications, relatively shorter range communication, and/or consume relatively lower power in comparison to the macro communications interfaces. There is no limitation that the OOB devices and interfaces be low power, short range, and/or low bandwidth. Devices may use any suitable out-of-band link, whether wireless or otherwise, such as IEEE 802.11, Bluetooth, PEANUT, UWB, ZigBee, an IP tunnel, a wired link, etc. Moreover, devices may utilize virtual OOB links, such as through use of IP based mechanisms over a wireless wide area network (WWAN) link (e.g., IP tunnel over a WWAN link) that acts as a virtual OOB link.

Femto-proxy modules 240a may provide various types of OOB functionality and may be implemented in various ways. A femto-proxy module 240a may have any of various configurations, such as a stand-alone processor-based system, a processor-based system integrated with a host device (e.g., access point, gateway, router, switch, repeater, hub, concentrator, etc.), etc. For example, the femto-proxy modules 240a may include various types of interfaces for facilitating various types of communications.

Some femto-proxy modules 240a include one or more OOB interfaces as part of the transceiver module 210 (e.g., a transceiver that may consume relatively low amounts of power in operation and/or may cause less interference than in the in-band spectrum) for communicating with other appropriately configured devices (e.g., an UE 115) for providing interference mitigation and/or femtocell selection herein through a wireless link. One example of a suitable communication interface is a Bluetooth-compliant transceiver that uses a time-division duplex (TDD) scheme.

Certain femto-proxy modules 240a may also include one or more backend network interfaces (e.g., packet switched network interface, circuit-switched network interface, radio network interface, control network interface, a wired link, and/or the like) for communicating with various devices or networks. For example, the femto-proxy module 240a may be in communication with the HNB 230a and/or other macro communication network 100a through backend network interfaces. A femto-proxy module 240a that is integrated within a host device, such as with HNB 230a, may utilize an internal bus or other such communication interface in the alternative to a backend network interface to provide communications between the femto-proxy module 240a and those other networks or devices, if desired. Additionally or alternatively, other interfaces, such as OOB interfaces, native cellular interfaces, etc., may be utilized to provide communication between the femto-proxy module 240a and the HNB 230a and/or other devices or networks.

Various communications functions (e.g., including those of the HNB 230a and/or the femto-proxy module 240a) may be managed using the communications management subsystem 250. For example, the communications management subsystem 250 may at least partially handle communications with the macro (e.g., WWAN) network, one or more OOB networks (e.g., piconets, UE 115 OOB radios, other femto-proxies, OOB beacons, etc.), one or more other femtocells (e.g., HNBs 230), UEs 115, etc. For example, the communications management subsystem 250 may be a component of the femto-proxy system 290a in communication with some or all of the other components of the femto-proxy system 290a via a bus.

Various other architectures are possible other than those illustrated by FIG. 2A. The HNB 230a and femto-proxy module 240a may or may not be collocated, integrated into a single device, configured to share components, etc. For example, the femto-proxy system 290a of FIG. 2A has an integrated HNB 230a and femto-proxy module 240a that at least partially share components, including the antennas 205, the transceiver module 210, the memory 215, and the processor module 225.

FIG. 2B shows a block diagram of a wireless communications system 200b that includes an architecture of a femto-proxy system 290b that is different from the architecture shown in FIG. 2A. Similar to the femto-proxy system 290a, the femto-proxy system 290b includes a femto-proxy module 240b and an HNB 230b. Unlike the system 290a, however, each of the femto-proxy module 240b and the HNB 230b has its own antennas 205, transceiver module 210, memory 215, and processor module 225. Both transceiver modules 210 are configured to communicate bi-directionally, via their respective antennas 205, with UEs 115. The transceiver module 210-1 of the HNB 230b is illustrated in bi-directional communication with the macro communications network 100b. The transceiver module 210-1 includes the network listen module 248 discussed above.

For the sake of illustration, the femto-proxy system 290b is shown without a separate communications management subsystem 250. In some configurations, a communications management subsystem 250 is provided in both the femto-proxy module 240b and the HNB 230b. In other configurations, the communications management subsystem 240 is implemented as part of the femto-proxy module 240b. In still other configurations, functionality of the communications management subsystem 250 is implemented as a computer program product (e.g., stored as software 220 in memory 215) of one or both of the femto-proxy module 240b and the HNB 230b.

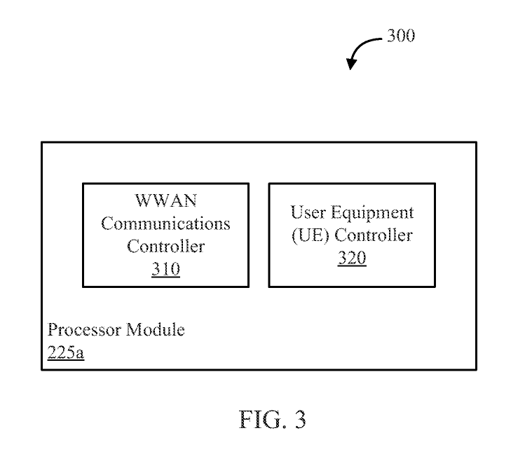

In yet other configurations, some or all of the functionality of the communications management subsystem 250 is implemented as a component of the processor module 225. FIG. 3 shows a block diagram 300 of a processor module 225a for implementing functionality of the communications management subsystem 250. The processor module 225a includes a WWAN communications controller 310 and a UE controller 320. The processor module 225a is in communication (e.g., as illustrated in FIGS. 2A and 2B) with the HNB 230 and the femto-proxy module 240. The WWAN communications controller 310 is configured to receive a WWAN communication (e.g., a page) for a designated UE 115. The UE controller 320 determines how to handle the communication, including affecting operation of the HNB 230 and/or the femto-proxy module 240.

Both the HNB 230a of FIG. 2A and the HNB 230b of FIG. 2B are illustrated as providing a communications link only to the macro communications network 100a. However, the HNB 230 may provide communications functionality via many different types of networks and/or topologies. For example, the HNB 230 may provide a wireless interface for a cellular telephone network, a cellular data network, a local area network (LAN), a metropolitan area network (MAN), a wide area network (WAN), the public switched telephone network (PSTN), the Internet, etc.

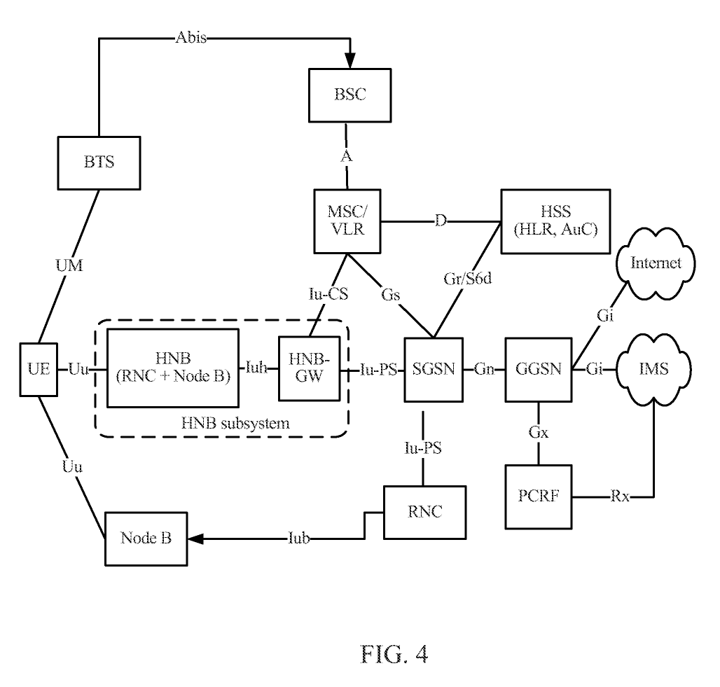

FIG. 4 shows further detail with respect to femtocell architecture in communication networks for providing various packet- and circuit-switched services. These architectures illustrate possible portions of the communications systems and networks shown in FIGS. 1-3.

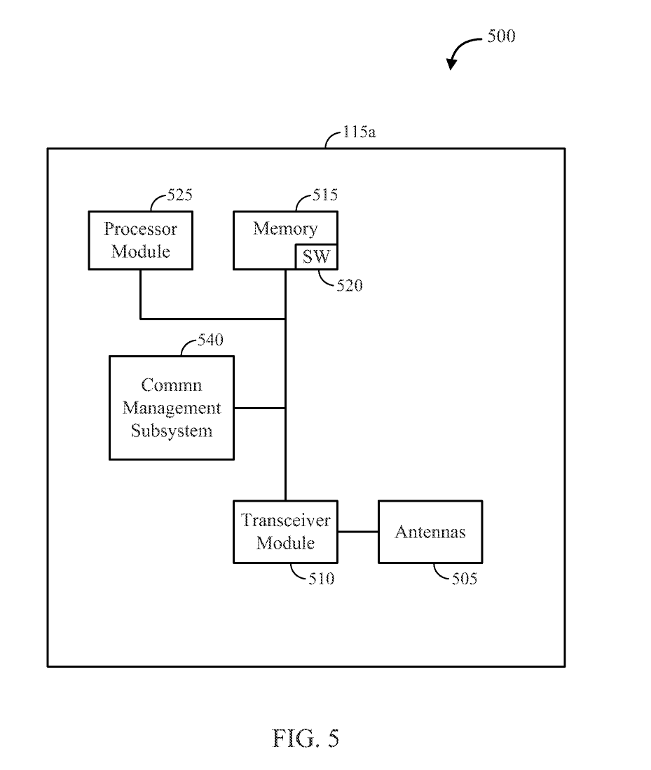

As described above, the femto-proxy systems 290 are configured to communicate with client devices, including the UEs 115. FIG. 5 shows a block diagram 500 of mobile user equipment (UE) 115a for use with the femto-proxy systems 290 of FIGS. 2A and 2B in the context of the communications systems and networks of FIGS. 1-4. The UE 115a may have any of various configurations, such as personal computers (e.g., laptop computers, netbook computers, tablet computers, etc.), cellular telephones, PDAs, digital video recorders (DVRs), internet appliances, gaming consoles, e-readers, etc. For the purpose of clarity, the UE 115a is assumed to be provided in a mobile configuration, having an internal power supply (not shown), such as a small battery, to facilitate mobile operation.

As described above, the femto-proxy systems 290 are configured to communicate with client devices, including the UEs 115. FIG. 5 shows a block diagram 500 of a UE 115a for use with the femto-proxy systems 290 of FIGS. 2A and 2B in the context of the communications systems and networks of FIGS. 1-4. The UE 115a may have any of various configurations, such as personal computers (e.g., laptop computers, netbook computers, tablet computers, etc.), cellular telephones, PDAs, digital video recorders (DVRs), internet appliances, gaming consoles, e-readers, etc. For the purpose of clarity, the UE 115a is assumed to be provided in a mobile configuration, having an internal power supply (not shown), such as a small battery, to facilitate mobile operation.

The UE 115a includes antennas 505, a transceiver module 510, memory 515, and a processor module 525, which each may be in communication, directly or indirectly, with each other (e.g., via one or more buses). The transceiver module 510 is configured to communicate bi-directionally, via the antennas 505 and/or one or more wired or wireless links, with one or more networks, as described above. For example, the transceiver module 510 is configured to communicate bi-directionally with Node Bs 105 of the macro communications network (e.g., the communications system 100 of FIG. 1), and, in particular, with at least one HNB 230.

As described above, the transceiver module 510 may be configured to further communicate over one or more OOB links. For example, the transceiver module 510 communicates with a femto-proxy system 290 (e.g., as described with reference to FIGS. 2A and 2B) over both an in-band (e.g., macro) link to the HNB 230 and at least one OOB link to the femto-proxy module 240. The transceiver module 510 may include a modem configured to modulate the packets and provide the modulated packets to the antennas 505 for transmission, and to demodulate packets received from the antennas 505. While the UE 115a may include a single antenna 505, the UE 115a will typically include multiple antennas 505 for multiple links.

The memory 515 may include random access memory (RAM) and read-only memory (ROM). The memory 515 may store computer-readable, computer-executable software code 520 containing instructions that are configured to, when executed, cause the processor module 525 to perform various functions described herein (e.g., call processing, database management, message routing, etc.). Alternatively, the software 520 may not be directly executable by the processor module 525 but be configured to cause the computer, e.g., when compiled and executed, to perform functions described herein.

The processor module 525 may include an intelligent hardware device, e.g., a central processing unit (CPU) such as those made by Intel® Corporation or AMD®, a microcontroller, an application specific integrated circuit (ASIC), etc. The processor module 525 may include a speech encoder (not shown) configured to receive audio via a microphone, convert the audio into packets (e.g., 30 ms in length) representative of the received audio, provide the audio packets to the transceiver module 510, and provide indications of whether a user is speaking Alternatively, an encoder may only provide packets to the transceiver module 510, with the provision or withholding/suppression of the packet itself providing the indication of whether a user is speaking

According to the architecture of FIG. 5, the UE 115a further includes a communications management subsystem 540. The communications management subsystem 540 may manage communications with the macro (e.g., WWAN) network, one or more OOB networks (e.g., piconets, femto-proxy modules 240, etc.), one or more femtocells (e.g., HNBs 230), other UEs 115 (e.g., acting as a master of a secondary piconet), etc. For example, the communications management subsystem 540 may be a component of the UE 115a in communication with some or all of the other components of the UE 115a via a bus. Alternatively, functionality of the communications management subsystem 540 is implemented as a component of the transceiver module 510, as a computer program product, and/or as one or more controller elements of the processor module 525.

The UE 115a includes communications functionality for interfacing with both the macro (e.g., cellular) network and one or more OOB networks (e.g., the femto-proxy module 240 link. For example, some UEs 115 include native cellular interfaces as part of the transceiver module 510 or the communications management subsystem 540 (e.g., a transceiver utilizing cellular network communication techniques that consume relatively large amounts of power in operation) for communicating with other appropriately configured devices (e.g., for establishing a link with a macro communication network via HNB 230) through a native cellular wireless link. The native cellular interfaces may operate according one or more communication standards, including, but not limited to, W-CDMA, UMTS, CDMA2000, GSM, WiMax, and WLAN.

Furthermore, the UEs 115 may also include OOB interfaces implemented as part of the transceiver module 510 and/or the communications management subsystem 540 (e.g., a transceiver that may consume relatively low amounts of power in operation and/or may cause less interference than in the in-band spectrum) for communicating with other appropriately configured devices through a wireless link. One example of a suitable OOB communication interface is a Bluetooth-compliant transceiver that uses a time-division duplex (TDD) scheme.

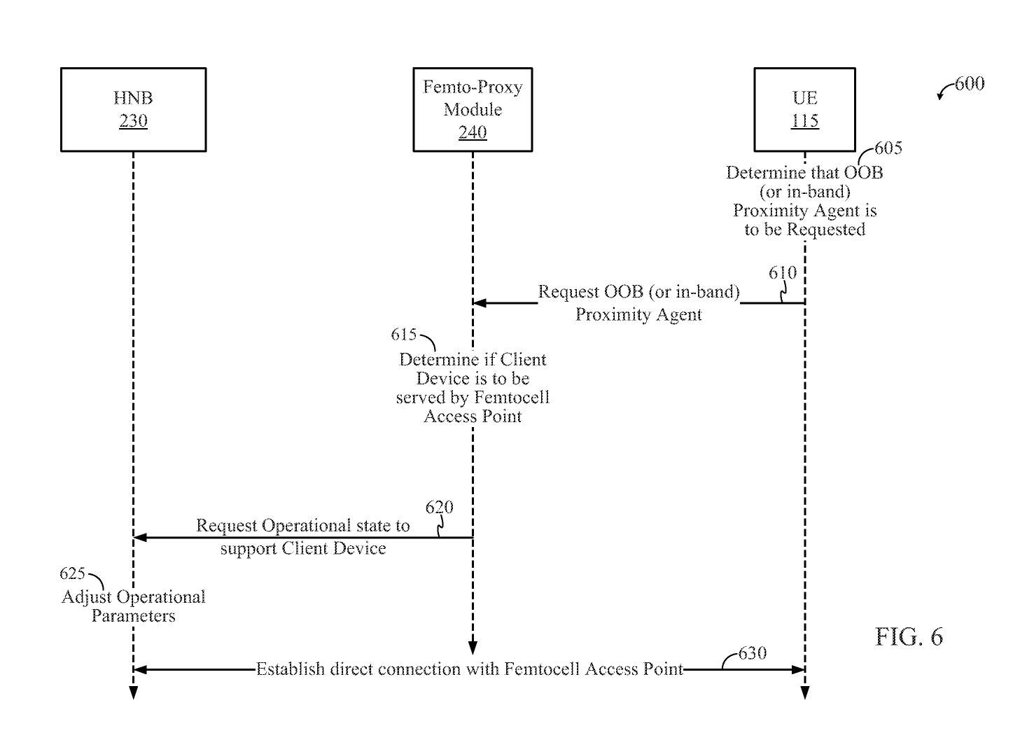

Referring to FIG. 6, a process 600 of providing out of band communication to assist in or otherwise facilitate femtocell functionality is shown. In operation, the UE 115 determines that services of a femto-proxy module 240 of a femto-proxy system 290 are to be requested at stage 605. Prior to that, a connection with the femto-proxy may be established. A connection to the femto-proxy module 240 may be implemented in a number of ways. For example, the UE 115 may determine that a trigger condition exists for requesting the services of the femto-proxy module 240. Additionally or alternatively, the UE 115 may actively scan for (e.g., using an OOB interface) a femto-proxy module 240 in proximity to the UE 115. Likewise, the femto-proxy module 240 may proactively operate to page the UEs 115 (e.g., transmitting a paging signal periodically).

For example, when an UE 115 is within range of such a femto-proxy module 240, the UE 115 may send a paging response whereby the UE 115 and the femto-proxy system 290 detect each other over the OOB link. Determinations to scan for a femto-proxy module 240 may be made, for example, when a current serving node (e.g., macro Node B 105) is providing adequate communication service and the UE 115 is searching for a femtocell (e.g., an HNB 230), as it is a preferred system. However, when a current serving node is not providing adequate communication service (e.g., signal strength is weak), traditional techniques for intra-frequency and inter-frequency scans may be utilized to search for a suitable node to provide service.

Trigger conditions that may cause the UE 115 to activate an OOB interface (e.g., Bluetooth radio) to send a femto-proxy module 240 inquiry or page include various measurements, determinations, etc., such as a macro pilot Ec/Io average threshold (e.g., −8 dB, −12 dB), the UE 115 being located in a preferred user zone (e.g., by analyzing location signatures), the AT's 115 location not changing for a period of time, etc. In establishing one or more trigger conditions, the UE 115 may collect location signatures (e.g., beacon signatures, macro signatures, zone signatures, etc., as described above) while in association with the femto-proxy module 240 and/or the HNB 230. Additionally or alternatively, the HNB 230 network listen (NL) may perform network environment measurements, whereby a network planning task may be run to predict the signatures within the service area of the HNB 230 and/or the femto-proxy module 240.

The foregoing signatures may be provided in a record, such as in a predetermined format (e.g., Primary Scrambling Code (PSC), Cell ID, international mobile subscriber identity (IMSI), Ec/Io etc.), for later use in determining that the UE 115 is in a location that the femto-proxy module 240 is to be requested. For example, as discussed above, the UE 115 may store the signatures in a memory thereof, perhaps marking or otherwise designating such signatures as proximity agent resource location (PARL) signatures. PARL signatures may utilize parameters in addition to or in the alternative to the foregoing exemplary parameters, such as PSC, RSCP, etc. Multiple such PARL signatures may be stored, such as to facilitate the femto-proxy module 240 operation at multiple locations (home, office, frequently visited location, etc.).

Whenever the UE 115 is in or near a location potentially represented by a PARL signature (e.g., the client device is camped on any of the corresponding macro Node Bs 105), the UE 115 may operate to compare a currently measured signature with the stored PARL signatures and trigger the OOB search process when a match is found (e.g., a match may mean that any of the macro Node B 105 pilots are within a threshold (±x) of its PARL signature value, for example). If, however, a signature or trigger condition is met, but a femto-proxy module 240 is not discovered within a few attempts, operation of the UE 115 may fall back on traditional or other resource selection techniques (e.g., traditional femtocell discovery approaches).

Operation to request femto-proxy module 240 services may result in little or even minimal impact on power consumption by the UE 115 adapted to operate with the femto-proxy module 240 (e.g., little or even minimal impact upon client device standby time), through use of trigger conditions to reduce or avoid background searches. That is, femto-proxy module 240 paging using OOB interfaces in the presence of trigger conditions as discussed above may consume less power than more traditional femtocell searches. Moreover, the UEs 115 adapted to operate with the femto-proxy module 240 may operate to perform a background search for an HNB 230 only when in proximity of the HNB 230 (e.g., when detecting the femto-proxy module 240), thereby providing power savings. The foregoing may be provided without causing significant interference to other UEs 115 operating in association with a macrocell of the network.

Having determined that a connection with the femto-proxy module 240 is desired, the UE 115 may initiate the OOB search process by sending pages or entering a page scan mode so that the UE 115 can be discovered by the femto-proxy system 290. An OOB connection is established between the femto-proxy module 240 in the femto-proxy system 290 and the UE 115 using OOB interfaces. With the UE 115 connected with the femto-proxy system 290, the in-band connection with the HNB 230 is then established. That is, the macro Node B 105 may handover the connection with the UE 115 to the femto HNB 230 in the femto-proxy system 290. Otherwise, if the UE 115 had no ongoing calls with the macro Node B 105 but was camping on the macro Node B 105, then the UE 115 reselects the HNB 230 in the femto-proxy system 290. In another example, the UE's 115 communication with the HNB 230 is established at the same time that the OOB link between the femto-proxy module 240 is being set-up.

At stage 605 in FIG. 6, the UE 115 may determine that it proxying services from the femto-proxy system 240 are desirable. The determination may be based on the fact that the UE's 115 communication with the HNB 230 is experiencing low activity. The UE 115 may issue a request for femto-proxy module 240 services using the proxy request message 610. For example, the UE 115 utilizes an OOB interface to communicate a proxy request message 610 to the a femto-proxy module 240 using the OOB link.

The femto-proxy module 240 may determine if the UE 115 is to be served by the HNB 230 associated with the femto-proxy module 240 at stage 615. For example, the HNB 230 may allow the proxying services only to particular, registered UEs 115. Additionally or alternatively, the HNB 230 may be able to accommodate a limited number, type, configuration, etc. of UEs, of which the UE 115 may or may not be included. Accordingly, the femto-proxy module 240 determines if the UE 115 is to be served by the HNB 230 prior to providing any instructions thereto to alter a state of the HNB 230. For example, the femto-proxy module 240 may utilize information such as electronic serial number (ESN), mobile identification number (MIN), international mobile subscriber identity (IMSI), temporary mobile subscriber identity (TMSI), internet protocol (IP) address, media access control (MAC) address, telephone number, and/or the like (e.g., provided by the UE 115 in the request for femto-proxy module 240 services) to compare with femtocell service information (e.g., stored by the femto-proxy module 240). Additionally or alternatively, the femto-proxy module 240 may utilize information provided from/to the HNB 230 for determining if the UE 115 is to be served by the HNB 230 (e.g., femtocell load information, UE 115 authorization information, etc.).

Having determined that the UE 115 is to be served by the HNB 230 at stage 615, the femto-proxy module 240 issues a request 620 for the HNB 230 to establish an operational state to support the UE 115. For example, the femto-proxy module 240 utilizes an internal communication bus (e.g., for integrated or co-located embodiments of the femto-proxy module 240 and HNB 230) to communicate the request to the HNB 230. Although the description above references use of an internal communication bus for communicating the aforementioned request between the femto-proxy module 240 and HNB 230, a different interface may be used, such as OOB interfaces, a backend network interface, etc.

The HNB 230 may adjust one or more operational parameters to facilitate serving the UE 115 in response to the request from the femto-proxy module 240 at stage 625. For example, the HNB 230 may add the UE 115 to a list of UEs whose packets experience additional buffering and examination. In this case, the desirable buffering delay for the UE 115 may be communicated to the HNB 230 in the request message 620.

The HNB 230 may perform functionality in addition to or in the alternative to the aforementioned operational state change in response to the request provided by the femto-proxy module 240. For example, the HNB 230 may perform validation of the UE 115 (in addition to or in the alternative to the validation of the UE 115 provided by the femto-proxy module 240), such as to ensure the UE 115 is an authorized femtocell client device (e.g., mapping of an authorized UE 115 identities for the femtocell and their BD ADDR may be maintained by the HNB 230 and/or the femto-proxy module 240).

Having adjusted one or more operational parameters to support communication with the UE 115, the HNB's 230 response 630 is communicated back to the UE 115 through the OOB link with the femto-proxy module 240 or directly using the in-band communication interface with the HNB 230. The UE 115 may then decide to power off its in-band communication interface(s) or put the in-band communication interface in reduced power mode since future communications with the HNB 230 can be monitored by the HNB 230 and/or femto-proxy module 240.

In another example, the request message 620 may not be sent to the HNB 230 in case the information for the proxy services are provided to the femto-proxy module 240 by the HNB 230. In this case, the support for the change of operational state is provided by the femto-proxy module 240 (e.g. the femto-proxy adds the UE 115 to the proxied UE list). In this case, the response message 630 may be generated by the femto-proxy module 240 and sent to the UE 115 through the OOB interface.

### Proxied UE Using HS-DSCH Intra-Node B Cell Chance Procedures

Referring again to FIG. 2A, the femto-proxy system 290a is configured to interact with the UE 115 to buffer data or otherwise hold data from the backhaul intended for the UE 115 in the HNB 230a. The data intended for the UE 115 is held in accordance with a High-Speed Downlink Shared Channel (HS-DSCH) cell change procedure. The femto-proxy module 240a can initiate the cell change procedure in order to inhibit transmission of the data to the UE 115 until the UE 115 is woken up from a reduced-power state to a full functionality state, or from any mode in which the UE 115 is unable to receive or inhibited from receiving data from the HNB 230a until the UE 115 changes into a mode in which it is able to receive the data properly.

The UE 115 is configured to operate in any of several modes. For example, the UE 115 can operate in a full functionality mode in which it can receive and send data from and to the HNB 230a acting as a Node B and an RNC. Further, the UE 115 can operate in a reduced-functionality mode. For example, the UE 115 can operate in a mode that has reduced power compared to the full functionality mode. Depending on the mode, different amounts and types of functions are disabled, and the UE 115 takes different amounts of time to wake up (typically longer as the number of disabled function increases). In the reduced-power mode, the UE 115 is “asleep” and is unable to receive data from the HNB 230a, or at least to receive all data sent to the UE 115 if the UE 115 is not woken up first. The UE 115 can be woken up to change the mode of the UE 115 from the low-power mode to the full-functionality mode such that the UE 115 can receive and process all data sent from the HNB 230a. If the UE 115 is in the low-power mode when data are sent from the HNB 230a, then some of these data may not be processed by the UE 115 while the UE 115 is waking up.

The femto-proxy module 240a is configured to communicate with the HNB 230a. The femto-proxy module 240a can monitor the source Node B 105 and/or the RNC 245 in the HNB 230a for incoming data intended for the UE 115. The femto-proxy module 240a might be enabled to look into data coming in to HNB 230a to determine whether data intended for one of the UEs 115 is intended for a UE 115 that is presently asleep, i.e., in a reduced-power mode, and thus presently proxied by the femto-proxy module 240a, e.g., by comparing an identifier of the proxied UE with the identifiers in the packets received and processed (and maybe buffered) in the RNC 245 or in the Node B 105.

The femto-proxy module 240a is further configured to send an indication to the RNC 245 that will induce an intra-Node B HS-DSCH cell change procedure by the RNC 245. The femto-proxy module 240a can produce and send an artificial or “fake” measurement report on behalf of the UE 115 to the RNC 245. This measurement report, for example, could indicate that the signal strength from the HNB 230a at the UE 115 is weak. This indication is independent of whether signal quality from the HNB 230a actually is of poor quality at the UE 115.

In another example, the femto-proxy module 240a can register the UE's identifier with the RNC 245. The RNC 245 checks the identifier in the received packets and possibly buffers data in the RNC 245 or the Node B 105. If a packet for the UE 115 is identified, the RNC 245 sends an indication to notify the femto proxy module 240a to generate the “fake” measurement report. Alternatively, the RNC 245 identifies that data is available for the UE 115 and internally generates the “fake” measurement report. In this case, the femto proxy module 240a may be notified by the RNC 245 of the generation of a “fake” measurement report for a proxied UE.

After the RNC 245 receives or generates the measurement report, the RNC 245 commences radio preparation for the cell change procedure using Radio Link(RL) prepare, ready, and commit messages. Then the RNC 245 sends physical channel reconfiguration messages to the UE 115.

The femto-proxy module 240a is further configured to intercept a physical channel reconfiguration message from the RNC 245 and provide a response to this message. The femto-proxy module 240a can respond to reception of the physical channel reconfiguration message from the RNC 245 by generating a physical channel reconfiguration complete message and transmitting the reconfiguration complete message to the RNC 245. The reconfiguration complete message provides an indication that the UE 115 is ready for communication with the HNB 230a in accordance with parameters provided by the RNC in the reconfiguration message, or at least that such communication will be available with the UE 115 upon expiration of a time indicated by the reconfiguration message.

Further, the femto-proxy module 240a is configured to provide a wake-up request to the UE 115. The proxy 240a is configured to respond to the reconfiguration message from the RNC 245 by sending the wake-up request to the UE 115 on an OOB channel using a frequency band other than the frequency band in which the HNB 230a communicates with the UE 115. For example the femto-proxy module 240a can send the wake-up request through an appropriate one of the antennas 205 using a short-range wireless transmission protocol such as the Bluetooth™ protocol.

During the Radio link preparation between the RNC 245 and the Node B 105, the RNC 245 will initiate an intra-Node B cell change procedure by sending a Radio link (RL) prepare signal in which the Node B 105 is both the source Node B (old channel Node B) and target Node B (new channel Node B), the source and target Node B antennas are the same, and the source and target frequencies are the same. In this case, since the target and the source cell are the same, data are not moved from one cell to another during the radio link preparation as is typically done in the inter Node B cell change procedure. The data, if originally buffered at the RNC 245, may be moved to the Node B 105 prior to the start of the RL preparation process. The Node B 105 can respond to the RL prepare message from the RNC 245 by producing and sending an RL ready message to the RNC 245 indicating that the Node B is ready to communicate with the UE 115 according to parameters provided by the RL prepare message. The RNC 245 is configured to respond to the RL ready message from the Node B 105 by producing and sending an RL commit message to the Node B 105. The RL commit message has an activation timer value that indicates an amount of time for the Node B 105 of the HNB 230a to wait (e.g. by buffering data for the UE 115) before communicating with the UE 115 or attempting to communicate with the UE 115 using the parameters specified in the RL prepare message.

The RNC 245 can set the activation timer value to be a single amount of time regardless of whether the measurement report is an artificial report from the RNC 245, femto-proxy module 240a or an actual measurement report from the UE 115. This amount of time is preferably sufficient for the UE 115 to be able to wake up (from any mode) in time for any communications to be received by the UE 115 from the Node B 105. For example, the RNC 245 can set the activation timer to the same value for all UEs, e.g., a period between about 200 milliseconds and about 350 milliseconds. For implementation ease, the RNC 245 may set the activation timer value to the same value for all user scenarios.

Alternatively, the RNC 245 may be configured to set different activation timer values depending on whether the measurement report is an artificial report from a femto-proxy module 240a versus an actual measurement report from a UE 115. In this case, the femto-proxy module 240a may be configured to provide a measurement report that is different from an actual measurement report from a UE 115. For example, there may be a toggle bit within the measurement report with an actual measurement report having the toggle bit set to zero and an artificial measurement report having the toggle bit set to one. The RNC 245 would be configured to analyze the toggle bit, determine the nature of the measurement report (i.e., artificial or actual), and initiate the appropriate inter-cell or intra-cell change. For example, the RNC 245 could respond to an artificial measurement report by setting an activation timer value that is longer than the activation timer value set in response to receipt of an actual measurement report from a UE 115. The activation timer value for the actual measurement report could be smaller in value relative to the activation timer value for an artificial measurement report because for an actual measurement report the UE 115 is awake.

In a case where the RNC 245 generates a “fake” measurement report due to the reception and identification of data for the UE 115, the RNC 245 is aware that the measurement report is fake or not. Thus, the RNC 245 can determine the appropriate activation timer to apply in the Radio Link preparation process.

In another example, regardless of the entity generating the “fake” measurement report, different activation timer values can be configured for each UE since the wake duration depends on the hardware, software, and features supported by each UE and hence, the wake duration can be different. Further, a preferred activation timer value can be communicated to the femto-proxy module 240a and/or the RNC 245, e.g., through the request messages 610 and 620 in FIG. 6.

If the RNC 245 is configured to default to an inter-cell change (where the source and target frequencies and/or Node B antennas are different), or if the RNC 245 is configured to preclude intra-cell changes, then the RNC 245 is configured to recognize and distinguish an artificial message report from the femto-proxy module 240a versus an actual message report from one of the UEs 115. In this case, the RNC 245 can override the default or the preclusion in order to allow an intra-cell change in response to the message report from the femto-proxy module 240a. If the RNC 245 is not configured to default to an inter-cell change or to preclude and intra-cell change, then the RNC 245 defaults to an intra-cell change in response to the message report from the femto-proxy module 240a indicating poor signal quality or the message internally generated within the RNC 245 due to the reception of data destined for the UE 115.

The UE 115 is configured to wake up in response to requests from the femto-proxy module 240a. The UE 115 can respond to the OOB wake-up request by producing and transmitting an OOB acknowledge message to the femto-proxy module 240a.

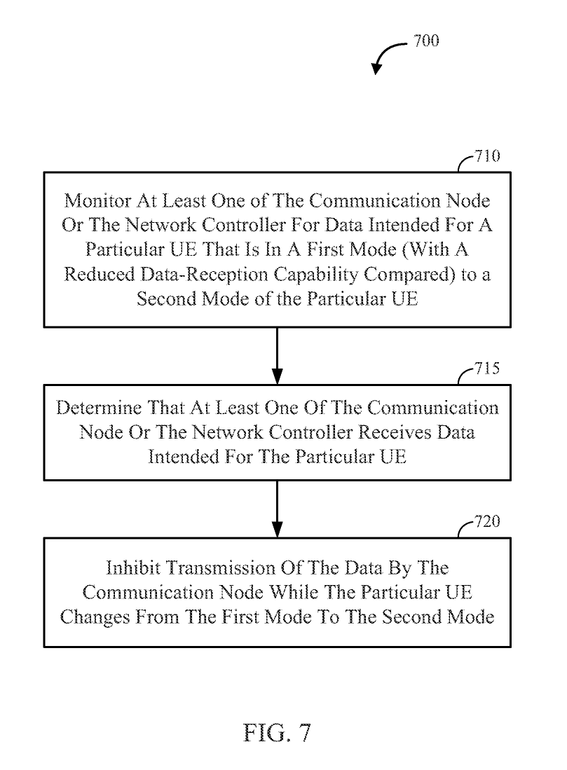

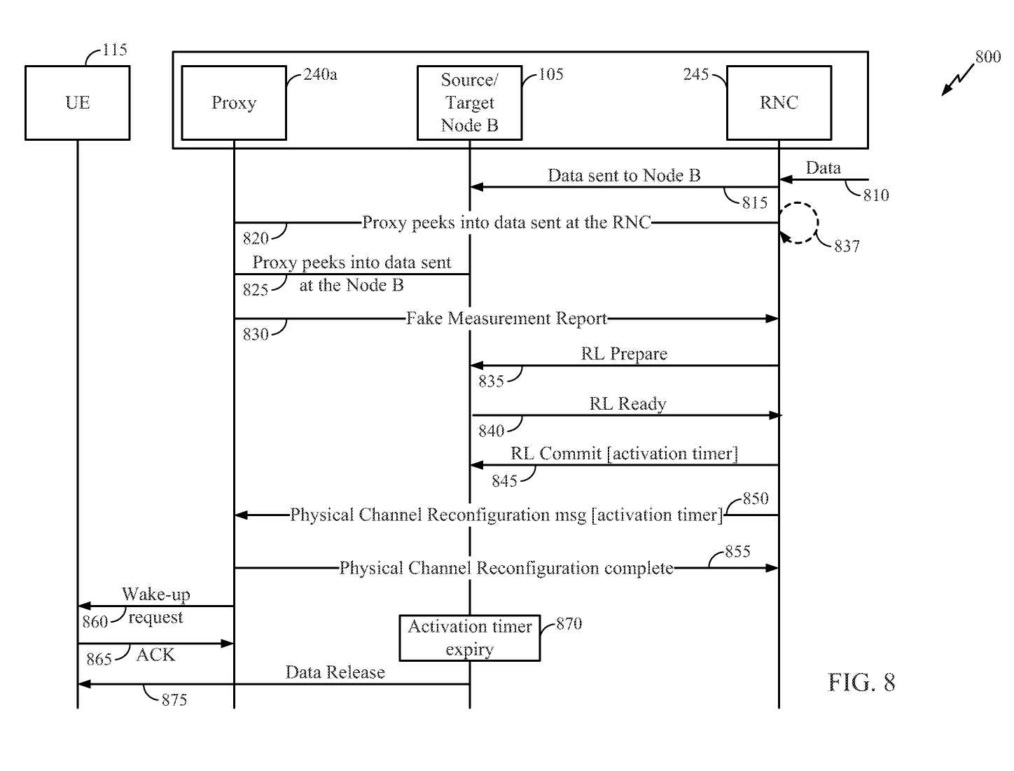

Referring to FIGS. 7-8, with further reference to FIGS. 1 and 2A, processes 700, 800 of proxying a UE and buffering data while the UE is woken up include the stages shown. The processes 700, 800 are, however, examples only and not limiting. The processes 700, 800 can be altered, e.g., by having stages added, removed, or rearranged. For example, stage 860 discussed below of sending a wake-up request from the femto-proxy module 240a to the UE 115 may be performed before stage 855 of sending a physical channel reconfiguration complete message from the femto-proxy module 240a to the RNC 245. Still other alterations to the processes 700, 800 are possible. In FIG. 8, the proxy (femto-proxy module) 240a, the Node B 105, and the RNC 245 are disposed in a single physical unit, e.g., in the femo-proxy system 290a, although one or more of these components can be disposed physically separate from the other components.

At stage 710, at least one of a network controller 245 or a Node B 105 is monitored for data intended for a particular UE 115 of the multiple UEs 115 (FIG. 1) where the UE 115 is presently in a first mode in which the UE 115 may have a reduced data-reception capability compared to a second mode of the UE 115. For example, the UE 115 shown in FIG. 8 is in a low-power mode in which the UE 115 is not in active communication with the HNB 230a. To receive data from the HNB 230a accurately, the UE 115 would first wake up and then receive data from the HNB 230a.

Referring to FIG. 8, during stage 710, data are received from the system backhaul at the RNC 245 at stage 810. At stage 815, the data received by the RNC 245 are sent to the Node B 105. The proxy 240a, at stages 820 and 825, views data received by the RNC 245 and the Node B 105, respectively. The proxy 240a communicates with the RNC 245 and/or the Node B 105 to view data in corresponding components.

At stage 715, the proxy 240a determines that at least one of the Node B 105 and/or the network controller 245 receives data intended for the UE 115. The proxy 240a analyzes the data observed or collected in the stage 820 and/or the stage 825 to determine which of the UEs 115 is intended to receive the data observed by the proxy 240a, e.g., by checking the UE IDs in the data. The proxy 240a analyzes the data to determine whether any data are intended for a UE 115 that is currently asleep (in a low-power mode) and thus presently proxied by the proxy 240a. Here, the proxy 240a in fact determines that data have been received by the RNC 245 and/or the Node B 105 intended for a UE 115 that is presently proxied by the proxy 240a.

At stage 720, transmission is inhibited of the data intended for the particular UE 115 by the Node B 105 while the particular UE 115 changes from the first mode in which the UE 115 is presently operating to the second mode in which the UE 115 will receive the data from the Node B 105. The proxy 240a initiates actions that will delay transmission of the data from the Node B 105 to the UE 115. At stage 830, the proxy 240a prepares and sends a fake measurement report (artificial measurement report) to the RNC 245 indicating poor signal quality for the UE 115 to which the data are intended. This will set in motion actions that will delay attempted transfer of the data from the HNB 230 to the UE 115 while the UE 115 is woken up.

Alternatively, stages 820, 825, 830 can be replaced by the RNC 245 generating the fake measurement report itself internally as indicated by alternative stage 837. The RNC 245 could analyze the incoming data from stage 810 against a list of proxied UEs to determine if the data are intended for a proxied UE and, if so, to generate the fake measurement report itself.

In response to the transmission of an artificial measurement report from the proxy 240a to the RNC 245, a new radio link is determined and configured. The RNC 245 responds to the indication of poor signal quality at the UE 115 by determining new parameters for a radio link from the UE 115 to the Node B 105. The new radio link is within the same cell as the radio link for which signal has been indicated to be poor. Here, the same cell means the same frequency and the same Node B antenna. At stage 835, having determined the parameters, the RNC 245 sends an RL prepare message indicating these parameters to the Node B 105. At stage 840, the Node B 105 responds to the RL prepare message from the RNC 245 by sending an RL ready message to the RNC 245 acknowledging the parameters from the RNC 245. At stage 845, the RNC 245 responds to the RL ready message from the Node B 105 by preparing an RL commit message and sending this message to the Node B 105. The RL commit message includes within it an indication of an activation timer value indicative of an amount of time for the Node B 105 to wait before sending the data to the UE 115 over the new channel indicated by the RL prepare message.

At stages 850 and 855, the RNC 245 and the proxy 240a communicate to establish the new physical channel for communication between the Node B 105 and the UE 115. The proxy 240a is acting in place of the UE 115, with the RNC 245 acting as though it was communicating with the UE 115 if the RNC 245 is communicating with the proxy 240a wirelessly (and thus possibly to other entities as well), but could communicate only to the proxy 240a through a wired connection. For example, the proxy 240a can receive the physical layer configuration message before the message is transmitted through the antenna. At stage 850, the RNC prepares and sends a physical channel reconfiguration message to the proxy 240a or to the UE 115 although the message is received by the proxy 240a. The physical channel reconfiguration message includes a UE activation timer value indicating an amount of time for the UE 115 to wait before attempting to communicate with the Node B 105. The UE timing value provided by the physical channel reconfiguration message can be different from the timing value provided by the RL commit message to the Node B 105. The two time values are selected such that the timers will expire at about the same time, preferably simultaneously, such that the Node B 105 and the UE 115 will be ready to receive communications from the other when each is cleared, as indicated by expiry of its respective timer, for sending communications to the other device. At stage 855, the proxy 240a sends a physical channel reconfiguration complete message to the RNC 245 to indicate that the parameters for the new channel have been processed such that communication with the Node B 105 over the channel indicated by the RNC 245 is ready or complete and communications can begin once the timers expire.

Either before or after sending the physical channel reconfiguration complete message, the proxy 240a sends a request to wake up the UE 115 in an OOB channel, e.g., using Bluetooth™. As shown, at stage 860, the proxy 240a sends the wake-up request to the UE 115 after sending the reconfiguration complete message. The wake-up request includes the UE activation timer value and configuration parameters for the new channel for the UE 115 to use when communicating with the Node B 105 as indicated in the physical channel reconfiguration message. The timer value in the wake-up message indicates to the UE 115 an amount of time to allow to elapse before attempting to communicate with the Node B 105. This timer value may be different from the timer value indicated in the physical channel configuration message, with the goal that the timers of the UE 115 and the Node B 105 expire at or near the same time. At stage 865, the UE 115 sends an acknowledgement to the proxy 240a indicating that the parameters have been processed as well as the UE timer value indicated by the wake-up request.

At stage 870, the activation timer in the Node B 105 expires. At stage 875, the Node B 105 transmits the data intended for the UE 115 to the UE 115.

Other configurations are within the scope and spirit of the disclosure and claims.

Techniques discussed herein may be particularly suited for deployment in existing networks. For example, systems may be deployed with no client device provisioning and no radio access network (RAN) configuration. Moreover, if an OOB proximity agent is not discovered, the client device may fall back on preexisting femtocell discovery and selection techniques, if desired. For example, normal search thresholds (e.g., Sintersearch threshold) may be retained such that when macrocell signal strength drops below such a threshold (e.g., CPICH Ec/Io<Sintersearch) the client device will search for cells to reselect even if out-of-band techniques of the client device do not detect an OOB femto-proxy. Accordingly, femtocell selection techniques may be aided rather than replaced.

The various operations of methods described above may be performed by any suitable means capable of performing the corresponding functions. The means may include various hardware and/or software component(s) and/or module(s), including, but not limited to a circuit, an application specific integrated circuit (ASIC), or processor.

The various illustrative logical blocks, modules, and circuits described may be implemented or performed with a general purpose processor, a digital signal processor (DSP), an application specific integrated circuit (ASIC), a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure, may be embodied directly in hardware, in a software module executed by a processor, or in a combination of the two. A software module may reside in any form of tangible storage medium. Some examples of storage media that may be used include random access memory (RAM), read only memory (ROM), flash memory, EPROM memory, EEPROM memory, registers, a hard disk, a removable disk, a CD-ROM and so forth. A storage medium may be coupled to a processor such that the processor can read information from, and write information to, the storage medium. In the alternative, the storage medium may be integral to the processor. A software module may be a single instruction, or many instructions, and may be distributed over several different code segments, among different programs, and across multiple storage media.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

The functions described may be implemented in hardware, software, firmware, or any combination thereof If implemented in software, the functions may be stored as one or more instructions on a tangible computer-readable medium. A storage medium may be any available tangible medium that can be accessed by a computer. By way of example, and not limitation, such computer-readable media can comprise RAM, ROM, EEPROM, CD-ROM, or other optical disk storage, magnetic disk storage, or other magnetic storage devices, or any other tangible medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material.

Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Further, modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

Various changes, substitutions and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. An apparatus for use in a wireless communication network that includes a wireless network user equipment (UE), a communication node, and a network controller, the apparatus comprising:
a first transceiver configured to communicate with another entity of the wireless network; and
a processor, communicatively coupled to the first transceiver, configured to determine that a particular UE is being proxied by a proxy of the network and configured to respond to an indication of receipt of data intended for the particular UE of the plurality of UEs by inducing an intra-cell change by the network controller for the particular UE.

2. The apparatus of claim 1 wherein the processor is configured to provide a request for the intra-cell change.

3. The apparatus of claim 2 wherein the apparatus is the proxy for the UE and the processor is configured to send the request toward the network controller, the request being a measurement report indicating a poor communication link to the particular UE.

4. The apparatus of claim 2 wherein the apparatus is the network controller and the processor is configured to produce the request, the request being a measurement report indicating a poor communication link to the particular UE.

5. The apparatus of claim 1 wherein the apparatus is the proxy and the first transceiver is configured to communicate with the plurality of UEs using a first frequency band that is different from a second frequency band in which the UEs are configured to communicate wirelessly with the communication node, the apparatus further comprising a second transceiver configured to communicate with the network node and the network controller using the second frequency band, wherein the processor is configured to respond to receipt of a channel reconfiguration message by sending a channel reconfiguration complete message toward the network controller, the channel reconfiguration message indicating parameters for a particular physical channel between the particular UE and the communication node, and the channel reconfiguration complete message indicating availability of communication with the particular UE using the particular physical channel.

6. The apparatus of claim 5 wherein the processor is further configured to respond to receiving the channel reconfiguration message by sending a wake-up request toward the particular UE via the first transceiver.

7. The apparatus of claim 5 wherein the first transceiver is configured to communicate wirelessly with the UEs using a short-range wireless protocol.

8. The apparatus of claim 1 wherein the processor is configured to induce a high-speed downlink shared channel cell change procedure at the network controller.

9. A computer program product for use in a wireless network that includes a wireless network user equipment (UE), a communication node, and a network controller, the computer program product comprising:
non-transitory processor-readable memory including processor-readable instructions configured to cause a processor to:
determine that data are to be sent from the communication node to the UE;
determine that the UE is presently in a mode in which the UE is unable to receive the data from the communication node; and
induce an intra-cell change by the network controller for the UE.

10. The computer program product of claim 9 wherein the instructions configured to cause the processor to induce are configured to cause the processor to provide a measurement report indicating a poor communication link to the UE.

11. The computer program product of claim 9 wherein the instructions configured to cause the processor to induce are configured to cause the processor to induce a high-speed downlink shared channel cell change procedure at the network controller.

12. The computer program product of claim 9 wherein the instructions configured to cause the processor to induce are configured to cause the processor to provide a request for an intra-cell change.

13. The computer program product of claim 9 wherein the instructions configured to cause the processor to induce are configured to cause the processor to send a communication toward the network controller.

14. The computer program product of claim 9 wherein the instructions configured to cause the processor to induce are configured to cause the processor to produce a fake measurement report within the network controller.

15. The computer program product of claim 9 wherein the memory further includes processor-readable instructions configured to cause the processor to respond to a channel reconfiguration message from the network controller intended for the UE by sending a channel reconfiguration complete message toward the network controller, the channel reconfiguration message indicating parameters for a particular physical channel between the UE and the communication node, and the channel reconfiguration complete message indicating availability of communication with the particular UE using the particular physical channel.

16. The computer program product of claim 15 wherein the memory further includes processor-readable instructions configured to cause the processor to respond to the channel reconfiguration message by initiating transmission of a wake-up request toward the UE using a frequency band other than that used by the UE to communicate with the communication node.

17. A method of proxying user equipment (UE) in a wireless communication network that includes a plurality of UEs, a communication node, and a network controller communicatively coupled to the communication node, the method comprising:
monitoring at least one of the network controller or the communication node for data intended for a particular UE of the plurality of UEs, wherein the particular UE is presently in a first mode in which the UE has reduced data-reception capability compared to a second mode of the UE;
determining that at least one of the network controller or the communication node receives data intended for the particular UE; and
inhibiting transmission of the data by the communication node while the particular UE changes from the first mode to the second mode.

18. The method of claim 17 wherein the inhibiting includes inducing an intra-cell change by the network controller for the particular UE.

19. The method of claim 18 further comprising:
sending a channel reconfiguration message from the network controller to the proxy indicating parameters for a physical channel between the particular UE and the communication node; and
sending a channel reconfiguration complete message from the proxy to the network controller indicating availability of communication with the particular UE using the physical channel.

20. The method of claim 19 further comprising sending the channel reconfiguration message including an activation timer indicating a desired time of sufficient length for the particular UE to change from the first mode to the second mode.

21. The method of claim 20 further comprising receiving a preferred value of the activation timer and transmitting the preferred value to the communication node.

22. The method of claim 18 wherein inducing the intra-cell change comprises sending a communication from a proxy of the particular UE to the network controller to induce a high-speed downlink shared channel cell change procedure.

23. The method of claim 18 wherein inducing the intra-cell change comprises producing a fake measurement report in the network controller.

24. The method of claim 17 further comprising sending a request from a proxy of the particular UE to the particular UE using a first frequency band that is different from a second frequency band that is used by the communication node and the particular UE to communicate with each other.

25. An apparatus for use in proxying user equipment (UE) in a wireless communication network that includes a plurality of UEs, a communication node, and a network controller communicatively coupled to the communication node, the apparatus comprising:
monitoring means for monitoring at least one of the network controller or the communication node for data intended for a particular UE of the plurality of UEs, wherein the particular UE is presently in a first mode in which the particular UE has reduced data-reception capability compared to a second mode of the particular UE;
determining means for determining receipt of data intended the particular UE; and
inhibiting means for inhibiting transmission of the data by the communication node while the particular UE changes from the first mode to the second mode.

26. The apparatus of claim 25 wherein the inhibiting means includes inducing means for inducing an intra-cell change by the network controller for the particular UE.

27. The apparatus of claim 26 wherein the inducing means are configured to send a communication toward the network controller to induce a high-speed downlink shared channel cell change procedure.

28. The apparatus of claim 27 wherein the communication is a measurement report indicating a poor communication link to the particular UE.

29. The apparatus of claim 26 wherein the inducing means are disposed in the network controller and are configured to produce a fake measurement report.

30. The apparatus of claim 25 further comprising means for responding to a channel reconfiguration message from the network controller indicating parameters for a physical channel between the particular UE and the communication node by sending a channel reconfiguration complete message toward the network controller indicating availability of communication with the particular UE using the physical channel.

31. The apparatus of claim 25 further comprising wake-up means for sending a request toward the particular UE for the particular UE to change from the first mode to the second mode, the wake-up means configured to send the request using a first frequency band that is different from a second frequency band that is used by the communication node and the particular UE to communicate with each other.

32. The apparatus of claim 25 further comprising the communication node and the network controller.
